(19) United States
(12) Patent Application Publication
(10) Pub. No.: US 2008/0128184 A1
(43) Pub. Date: Jun. 5, 2008

(54) LUBRICATING OIL COMPOSITIONS HAVING IMPROVED CORROSION AND SEAL PROTECTION PROPERTIES

(76) Inventors: John T. Loper, Richmond, VA (US); Paul G. Griffin, Glen Allen, VA (US); William Y. Lam, Glen Allen, VA (US)

Correspondence Address: LUEDEKA, NEELY & GRAHAM, P.C., P O BOX 1871, KNOXVILLE, TN, 37901, US

(21) Appl. No.: 11/565,243

(22) Filed: Nov. 30, 2006

(51) Int. Cl. C10M 137/10; C10M 169/06; B60K 11/00; F01M 11/00; C10M 159/24

(52) U.S. Cl. 180/54.1; 508/110; 508/391; 508/371; 123/196 R

(57) ABSTRACT

A fully formulated lubricating oil, lubricated surface, and lubricant additive concentrates for lubricants providing improved lubricant characteristics. The lubricating oil composition has therein a dispersant mixture derived from a reaction product of polyalkylene compound, a carboxylic acylating agent, and a polyamine. The polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

### TECHNICAL FIELD

The disclosure relates to lubricating oil compositions. More particularly, the disclosure relates to lubricating oil compositions exhibiting improved properties for protecting lubricated components and seals.

### BACKGROUND AND SUMMARY

Lubricating oil compositions used to lubricate internal combustion engines contain a base oil of lubricating viscosity, or a mixture of such oils, and additives used to improve the performance characteristics of the oil. For example, additives are used to improve detergency, to reduce engine wear, to provide stability against heat and oxidation, to reduce oil consumption, to inhibit corrosion, to reduce sludge, and to reduce friction loss. Some additives provide multiple benefits, such as dispersant-viscosity modifiers. Other additives, while improving one characteristic of the lubricating oil, have an adverse effect on other characteristics. Thus, to provide lubricating oil having optimal overall performance, it is necessary to characterize and understand all the effects of the various additives available, and carefully balance the additive content of the lubricant.

Despite advances made in lubricant technology, newer engines typically require a difference balance of performance characteristics. Accordingly, there continues to be a need for more cost effective lubricant compositions that provide equivalent or superior performance for use in newer, more energy efficient engine applications.

In view of the foregoing, exemplary embodiments of the disclosure provide a fully formulated lubricating oil, lubricated surface, and lubricant additive concentrates for providing improved lubricant characteristics. The lubricating oil composition has therein a dispersant mixture derived from a reaction product of polyalkylene compound, a carboxylic acylating agent, and a polyamine. The polyalkylene compound of at least one dispersant in the dispersant mixture has a number average molecular weight of at least about 1200 and at least one dispersant in the dispersant mixture contains boron with a weight ratio of boron to nitrogen (B/N) of the dispersant mixture ranging from above about 0.25 to about 1.0.

In accordance with a second aspect, the disclosure provides a lubricated surface having thereon a lubricant composition containing a base oil of lubricating viscosity and an additive package including a dispersant mixture derived from a reaction product of polyalkylene compound, a carboxylic acylating agent, and a polyamine. The polyalkylene compound of at least one dispersant in the dispersant mixture has a number average molecular weight of at least about 1200 and at least one dispersant in the dispersant mixture contains boron with a weight ratio of boron to nitrogen (B/N) of the dispersant mixture ranging from above about 0.25 to about 1.0.

In accordance with a third aspect, the disclosure provides a vehicle having moving parts and containing a lubricant for lubricating the moving parts. The lubricant includes an oil of lubricating viscosity and an additive package containing a dispersant mixture derived from a reaction product of polyalkylene compound, a carboxylic acylating agent, and a polyamine. The polyalkylene compound of at least one dispersant in the dispersant mixture has a number average molecular weight of at least about 1200 and at least one dispersant in the dispersant mixture contains boron with a weight ratio of boron to nitrogen (B/N) of the dispersant mixture ranging from above about 0.25 to about 1.0.

Yet another aspect of the disclosure provides a lubricant additive concentrate for providing reduced sludge in a lubricant composition containing a lubricant additive. The lubricant additive comprises a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron with a weight ratio of boron to nitrogen (B/N) of the dispersant mixture ranging from above about 0.25 to about 1.0.

Still another aspect of the disclosure provides a fully formulated lubricant composition having a base oil component of lubricating viscosity and an amount of sludge reducing lubricant additive. The lubricant additive includes a dispersant mixture derived from a reaction product of polyalkylene compound, a carboxylic acylating agent, and a polyamine. The polyalkylene compound of at least one dispersant in the dispersant mixture has a number average molecular weight of at least about 1200 and at least one dispersant in the dispersant mixture contains boron with a weight ratio of boron to nitrogen (B/N) of the dispersant mixture ranging from above about 0.25 to about 1.0.

An advantage of the disclosed embodiments is a significant improvement in sludge reduction over compositions containing conventional succinimide dispersants. An unexpected advantage of the disclosed embodiments is that the lubricant compositions may exhibit a greater degree of corrosion protection and have less adverse affects on seal materials than conventional lubricant compositions. Other and further objects, advantages and features of the disclosed embodiments may be understood by reference to the following.

### DESCRIPTION OF THE EXEMPLARY EMBODIMENTS

### Dispersants

A primary component of lubricant compositions having improved lubricating characteristics according to the disclosure is mixture of dispersants selected from the group consisting of dispersants derived from highly reactive polyalkylene compounds and boronated dispersants derived from polyalkylene compounds and highly reactive polyalkylene compounds. Dispersants which may be used include, but are not limited to, amine, alcohol, amide, or ester polar moieties attached to the polymer backbone often via a bridging group. Dispersants may be selected from Mannich dispersants as described, for example, in U.S. Pat. Nos. 3,697,574 and 3,736,357; ashless succcinimide dispersants as described in U.S. Pat. Nos. 4,234,435 and 4,636,322; amine dispersants as described in U.S. Pat. Nos. 3,219,666, 3,565,804, and 5,633,326; Koch dispersants as described in U.S. Pat. Nos. 5,936,041, 5,643,859, and 5,627,259, and polyalkylene succinimide dispersants as described in U.S. Pat. Nos. 5,851,965; 5,853,434; and 5,792,729.

As used herein the term “succinimide” is meant to encompass the completed reaction product from a reaction between a hydrocarbyl substituted succinic acylating agent and a polyamine and is intended to encompass compounds wherein the product may have amide, amidine, and/or salt linkages in addition to the imide linkage of the type that results from the reaction of a primary amino group and an anhydride moiety.

Of the succinimides, succinimides derived from an aliphatic hydrocarbyl substituted succinic acylating agent in which the hydrocarbyl substituent contains an average of at least 40 carbon atoms are particularly suitable dispersants. Particularly suitable for use as the acylating agent is (a) at least one polyisobutenyl substituted succinic acid or (b) at least one polyisobutenyl substituted succinic anhydride or (c) a combination of at least one polyisobutenyl substituted succinic acid and at least one polyisobutenyl substituted succinic anhydride in which the polyisobutenyl substituent in (a), (b) or (c) is derived from polyisobutene or a highly reactive polyisobutene having a number average molecular weight in the range of 400 to 5,000.

For the purposes of this disclosure, the term “highly reactive” means that a number of residual vinylidene double bonds in the compound is greater than about 45%. For example, the number of residual vinylidene double bonds may range from about 50 to about 85 % in the compound. The percentage of residual vinylidene double bonds in the compound may be determined by well-known methods, such as for example Infra-Red Spectroscopy or C₁₃ Nuclear Magnetic Resonance or a combination thereof. A process for producing such compounds is described, for example, in U.S. Pat. No. 4,152,499. For example, a polyisobutene having a ratio of weight average molecular weight to number average molecular weight ranging from about 1 to about 6.

A particularly suitable dispersant is a polyalkylene succinimide dispersant derived from the polyisobutene (PIB) compound described above wherein the dispersant has a reactive PIB content of at least about 45%. The dispersant may be a mixture of dispersants having number average molecular weights ranging from about 800 to about 3000 and reactive PIB contents of from about 50 to about 60%. The total amount of dispersant in the lubricant composition may range from about 1 to about 10 percent by weight of the total weight of the lubricant composition.

In preparing the substituted succinic acylating agents, the polyalkylene compound is reacted with one or more maleic or fumaric acidic reactants. Ordinarily the maleic or fumaric reactants will be maleic acid, fumaric acid, maleic anhydride, or a mixture of two or more of these. The maleic reactants are usually selected over the fumaric reactants because the former are more readily available and are, in general, more readily reacted with the polyalkenes (or derivatives thereof) to prepare the substituted succinic acylating agents. Thus use can be made of dibasic acids and anhydrides, esters and acyl halides thereof which contain a total of up to 12 carbon atoms in the molecule (excluding carbon atoms of an esterifying alcohol). Among such compounds are azelaic acid, adipic acid, succinic acid, lower alkyl-substituted succinic acid, succinic anhydride, lower alkyl-substituted succinic anhydride, glutaric acid, pimelic acid, suberic acid, sebacic acid, and like dibasic acids, anhydrides, acyl halides, and esters which contain (excluding carbon atoms of esterifying alcohols) up to 12 carbon atoms in the molecule. Most suitable are maleic acid, maleic anhydride, fumaric acid and malic acid. An average acid to polyalkylene ratio in the dispersant is suitably about 1.7:1 or greater. A typical range is from about 1.7:1 to about 2.0:1.

Any of a variety of known procedures can be used to produce the substituted succinic acylating agents. Details concerning procedures for producing the substituted acylating agents have been extensively described in the patent literature, such as for example in U.S. Pat. No. 4,234,435.

Another principal reactant used to make the succinimide dispersants is one or a mixture of polyamines which may has at least one primary amino group in the molecule and which additionally may contain an average of at least two other amino nitrogen atoms in the molecule. For best results, the polyamines should contain at least two primary amino groups in the molecule.

One suitable type of polyamine is comprised of alkylene polyamines such as those represented by the formula

H₂N(CH₂)ₙ(NH(CH₂)ₙ)ₘNH₂

wherein n is 2 to about 10, and m is 0 to 10. Illustrative are ethylene diamine, diethylene triamine, triethylene tetramine, tetraethylene pentamine, spermine, pentaethylene hexamine, propylene diamine (1,3-propanediamine), butylene diamine (1,4-butanediamine), hexamethylene diamine (1,6-hexanediamine), decamethylene diamine (1,10-decanediamine), and the like. Preferred for use is tetraethylene pentamine or a mixture of ethylene polyamines which approximates tetraethylene pentamine.

Another type of polyamine that may be used is comprised of a hydrocarbyl polyamine containing from 10 to 50 weight percent acyclic alkylene polyamines and 50 to 90 weight percent cyclic alkylene polyamines. Such mixture may be a mixture consisting essentially of polyethylene polyamines, especially a mixture having an overall average composition approximating that of polyethylene pentamine or a mixture having an overall average composition approximating that of polyethylene tetramine. Another useful mixture has an overall average composition approximating that of polyethylene hexamine. In this connection, the terms “polyalkylene” and “polyethylene”, when utilized in conjunction with such terms as “polyamine”, “tetramine”, “pentamine”, “hexamine”, etc., denote that some of the adjacent nitrogen atoms in the product mixture are joined by a single alkylene group whereas other adjacent nitrogen atoms in the product mixture are joined by two alkylene groups thereby forming a cyclic configuration, i.e., a substituted piperazinyl structure.

Also suitable are aliphatic polyamines containing one or more ether oxygen atoms and/or one or more hydroxyl groups in the molecule. Mixtures of various polyamines of the type referred to above are also suitable.

In principle, therefore, any polyamine having at least one primary amino group and an average of at least three amino nitrogen atoms in the molecule may be used in forming the succinimides described herein. Product mixtures known in the trade as “triethylene tetramine”, “tetraethylene pentamine”, and “pentaethylene hexamine” are typically used. A dispersant derived from the polyalkylene compound, acylating agent, and polyamine suitably contains greater than about 1.7 di-carboxylic acid producing moities per polyalkenyl moiety in the molecule.

As set forth above, the dispersant may be a boronated dispersant. Accordingly, the mixture of dispersant may include a boronated dispersant and a non-boronated dispersant. Either one or both of the boronated and non-boronated dispersants may be made with a highly reactive polyalkylene compound as set forth above. Boronated dispersants may be made by reacting a boron compound or mixture of boron compounds capable of introducing boron-containing species into the dispersants before, during or subsequent to the reaction forming the dispersants. Any boron compound, organic or inorganic, capable of undergoing such reaction may be used. Accordingly, use may be made of such inorganic boron compounds as the boron acids, and the boron oxides, including their hydrates. Typical organic boron compounds include esters of boron acids, such as the orthoborate esters, metaborate esters, biborate esters, pyroboric acid esters, and the like. Thus, use may be made of such compounds as, for example, boron acids such as boric acid, boronic acid, tetraboric acid, metaboric acid, pyroboric acid, esters of such acids, such as mono-, di- and tri-organic esters with alcohols having 1 to 20 carbon atoms, e.g., methanol, ethanol, propanol, isopropanol, the butanols, the pentanols, the hexanols, the octanols, the decanols, ethylene glycol, propylene glycol and the like, and boron oxides such as boron oxide and boron oxide hydrate.

In conducting the foregoing boronation reaction, any temperature at which the desired reaction occurs at a satisfactory reaction rate may be used. Such reactions may be conducted in the presence or absence of an ancillary diluent or liquid reaction medium, such as a mineral lubricating oil solvent. If the reaction is conducted in the absence of an ancillary solvent of this type, such is usually added to the reaction product on completion of the reaction. In this way the final product is in the form of a convenient solution in lubricating oil and thus is compatible with a lubricating oil base stock.

The amount of boron reactant used should be sufficient to introduce up to about 5 wt. %, typically, from about 0.05 to about 2.5 wt.%, (expressed as weight % of elemental boron) into the dispersant or mixture of dispersants to provide a weight ratio of boron to nitrogen in the dispersant mixture ranging from about 0.25 to about 1.0.

### Base Oils

The dispersant mixture described above may be included in a wide variety of base stocks to provide a lubricant composition. Definitions for the base stocks and base oils available for use in the exemplary embodiments of the disclosure are the same as those found in the American Petroleum Institute (API) publication “Engine Oil Licensing and Certification System”, Industry Services Department, Fourteenth Edition, December 1996, Addendum 1, December 1998. The foregoing publication categorizes base stocks as follows:
a) Group I base stocks containing less than 90 percent saturates and/or greater than 0.03 percent sulfur and having a viscosity index greater than or equal to 80 and less than 120 using the test methods specified in Table 1.
b) Group II base stocks containing greater than or equal to 90 percent saturates and less than or equal to 0.03 percent sulfur and having a viscosity index greater than or equal to 80 and less than 120 using the test methods specified in Table 1.
c) Group III base stocks containing greater than or equal to 90 percent saturates and less than or equal to 0.03 percent sulfur and having a viscosity index greater than or equal to 120 using the test methods specified in Table 1.
d) Group IV base stocks that are polyalphaolefins (PAO).
e) Group V base stocks that include all other base stocks not included in Group I, II, III, or IV.

The most desirable base oils for lubricant compositions according to the disclosure are base oils meeting current ILSAC GF-4 and API SM specifications.

The base oil including the dispersant may include other additive components selected from friction modifiers, antiwear agents, antioxidants, antifoam agents, detergents, and the like. Such additive components are typically used in conventional amounts to provide a fully formulated lubricant composition. For the purpose of this disclosure, the foregoing terms relate to primary characteristics of the additive components. It will be appreciated that many of the components may perform multiple functions in the lubricant compositions. Accordingly, classification of the additive components is merely for convenience and is not intended to limit the scope of the claimed embodiments.

### Friction Modifiers

One or more oil soluble friction modifier may be incorporated in the lubricating oil compositions described herein. The friction modifiers may be selected from metal containing, nitrogen-containing, nitrogen-free and/or amine free friction modifiers. Typically, the friction modifiers may be used in an amount ranging from about 0.02 to 2.0 wt. % of the lubricating oil composition. Desirably, from 0.05 to 1.0, more desirably from 0. 1 to 0.5, wt. % of the friction modifiers is used.

Suitable metal containing friction modifiers include hydrocarbon soluble titanium, zinc and molybdenum compounds. The terms “hydrocarbon soluble,” “oil soluble,” or “dispersable” are not intended to indicate that the compounds are soluble, dissolvable, miscible, or capable of being suspended in a hydrocarbon compound or oil in all proportions. The terms do mean, however, that they are, for instance, soluble or stably dispersible in oil to an extent sufficient to exert their intended effect in the environment in which the oil is employed. Moreover, the additional incorporation of other additives may also permit incorporation of higher levels of a particular additive, if desired.

As used herein, “hydrocarbon” means any of a vast number of compounds containing carbon, hydrogen, and/or oxygen in various combinations. The term “hydrocarbyl” refers to a group having a carbon atom directly attached to the remainder of the molecule and having predominantly hydrocarbon character. Examples of hydrocarbyl groups include:
(i) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic radical);
(ii) substituted hydrocarbon substituents, that is, substituents containing non-hydrocarbon groups which, in the context of the description herein, do not alter the predominantly hydrocarbon substituent (e.g., halo (especially chloro and fluoro), hydroxy, alkoxy, mercapto, alkylmercapto, nitro, nitroso, and sulfoxy);
(iii) hetero-substituents, that is, substituents which, while having a predominantly hydrocarbon character, in the context of this description, contain other than carbon in a ring or chain otherwise composed of carbon atoms. Hetero-atoms include sulfur, oxygen, nitrogen, and encompass substituents such as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

Importantly, the organo groups of the ligands have a sufficient number of carbon atoms to render the compound soluble or dispersible in the oil or hydrocarbon fluid. For example, the number of carbon atoms in each group will generally range between about 1 to about 100, preferably from about 1 to about 30, and more preferably between about 4 to about 20.

A suitable metal containing friction modifier for the lubricating oil compositions disclosed herein, is a hydrocarbon-soluble titanium compound having friction modifying and/or extreme pressure, and/or antioxidant, and/or anti-wear properties in lubricating oil compositions. The hydrocarbon soluble titanium compounds suitable for use as a herein, for example as a friction modifier may be provided by a reaction product of a titanium alkoxide and an about C₆ to about C₂₅ carboxylic acid. The reaction product may be represented by the following formula:

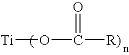

wherein n is an integer selected from 2, 3 and 4, and R is a hydrocarbyl group containing from about 5 to about 24 carbon atoms, or by the formula:

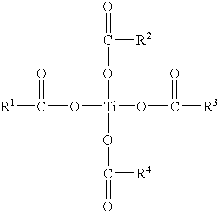

wherein each of R¹, R², R³, and R⁴ are the same or different and are selected from a hydrocarbyl group containing from about 5 to about 25 carbon atoms. Compounds of the foregoing formulas are essentially devoid of phosphorous and sulfur.

Examples of titanium/carboxylic acid products include, but are not limited to, titanium reaction products with acids selected from the group consisting essentially of caproic acid, caprylic acid, lauric acid, myristic acid, palmitic acid, stearic acid, arachidic acid, oleic acid, erucic acid, linoleic acid, linolenic acid, cyclohexanecarboxylic acid, phenylacetic acid, benzoic aicd, neodecanoic acid, and the like. Methods for making such titanium/carboxylic acid products are described, for example, in U.S. Pat. No. 5,260,466, the disclosure of which is incorporated herein by reference.

The hydrocarbon soluble titanium compounds of the embodiments described herein are advantageously incorporated into lubricating compositions. Accordingly, the hydrocarbon soluble titanium compounds may be added directly to the lubricating oil composition. In one embodiment, however, hydrocarbon soluble titanium compounds are diluted with a substantially inert, normally liquid organic diluent such as mineral oil, synthetic oil (e.g., ester of dicarboxylic acid), naptha, alkylated (e.g., C₁₀-C₁₃ alkyl) benzene, toluene or xylene to form a metal additive concentrate. The titanium additive concentrates usually contain from about 0% to about 99% by weight diluent oil.

The lubricating compositions of the disclosed embodiment contain the titanium compound in an amount providing the compositions with at least 1 ppm of titanium. An amount of at least 10 ppm of titanium from a titanium compound has been found to be effective to provide friction modification alone or in combination with a second friction modifier selected from nitrogen containing friction modifiers; organic polysulfide friction modifiers; amine-free friction modifiers, and organic, ashless, nitrogen-free friction modifiers.

Desirably, the titanium metal from a titanium compound is present in the lubricant composition in an amount of from about 1 ppm to about 1500 ppm, such as 10 ppm to 1000 ppm, more desirably from about 50 ppm to 500 ppm, and still more desirably in an amount of from about 75 ppm to about 250 ppm, based on the total weight of the lubricating composition. Because such titanium compounds may also provide antiwear credits to lubricating oil compositions, the use thereof may allow for a reduction in the amount of metal dihydrocarbyl dithiophosphate antiwear agent (e.g., ZDDP) employed. Industry trends are leading to a reduction in the amount of ZDDP being added to lubricating oils to reduce the phosphorous content of the oil to below 1000 ppm, such as to 250 ppm to 750 ppm, or 250 ppm to 500 ppm. To provide adequate wear protection in such low phosphorous lubricating oil compositions, the titanium compound should be present in an amount providing at least 50 ppm by mass of titanium. The amount of titanium and/or zinc may be determined by Inductively Coupled Plasma (ICP) emission spectroscopy using the method described in ASTM D5185.

Zinc containing friction modifiers may include, but are not limited to, zinc carboxylates. Examples of zinc carboxylates include zinc reaction products with acids selected from the group consisting essentially of caproic acid, caprylic acid, lauric acid, myristic acid, palmitic acid, stearic acid, arachidic acid, oleic acid, erucic acid, linoleic acid, linolenic acid, cyclohexanecarboxylic acid, phenylacetic acid, benzoic aicd, neodecanoic acid, and the like. Methods for making zinc/carboxylic acid products are described, for example, in U.S. Pat. No. 3,367,869. A particularly suitable zinc carboxylate is zinc oleate which may be used alone or in combination with a second friction modifier. The amount of zinc carboxylate in a lubricant composition may be sufficient to provide from about 50 to about 1500 parts per million (ppm) zinc in a fully formulated lubricant composition.

Another metal containing friction modifier that may be used includes a hydrocarbon soluble molybdenum containing friction modifier. Such molybdenum containing friction modifiers are well known in the art and may be used in an amount sufficient to provide from about 10 to about 500 ppm molybdenum to a finished lubricant composition.

Examples of nitrogen containing friction modifiers that may be used include, but are not limited to, imidazolines, amides, amines, succinimides, alkoxylated amines, alkoxylated ether amines, amine oxides, amidoamines, nitriles, betaines, quaternary amines, imines, amine salts, amino guanadine, alkanolamides, and the like.

Such friction modifiers may contain hydrocarbyl groups that may be selected from straight chain branched chain or aromatic hydrocarbyl groups or admixtures thereof, and may be saturated or unsaturated. Hydrocarbyl groups are predominantly composed of carbon and hydrogen but may contain one or more hetero atoms such as sulfur or oxygen. The hydrocarbyl groups range from 12 to 25 carbon atoms and may be saturated or unsaturated. More preferred are those with linear hydrocarbyl groups.

Exemplary friction modifiers include amides of polyamines. Such compounds may have hydrocarbyl groups that are linear, either saturated or unsaturated or a mixture thereof and contain no more than about 12 to about 25 carbon atoms.

Other exemplary friction modifiers include alkoxylated amines and alkoxylated ether amines, with alkoxylated amines containing about two moles of alkylene oxide per mole of nitrogen being the most preferred. Such compounds can have hydrocarbyl groups that are linear, either saturated, unsaturated or a mixture thereof. They contain no more than about 12 to about 25 carbon atoms and may contain one or more hetero atoms in the hydrocarbyl chain. Ethoxylated amines and ethoxylated ether amines are particularly suitable nitrogen-containing friction modifiers. The amines and amides may be used as such or in the form of an adduct or reaction product with a boron compound such as a boric oxide, boron halide, metaborate, boric acid or a mono-, di- or tri-alkyl borate.

The ashless organic polysulfide compounds that may be used as friction modifiers include organic compounds expressed by the following formulae, such as sulfides of oils or fats or polyolefins, in which a sulfur atom group having two or more sulfur atoms adjoining and bonded together is present in a molecular structure.

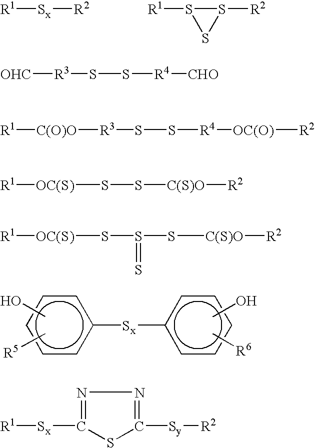

In the above formulae, R¹ and R² independently denote a straight-chain, branched-chain, alicyclic or aromatic hydrocarbon group in which a straight chain, a branched chain, an alicyclic unit and an aromatic unit may be selectively contained in any combined manner. An unsaturated bond may be contained, but a saturated hydrocarbon group is desirable. Among them, alkyl group, aryl group, alkylaryl group, benzyl group, and alkylbenzyl group are particularly desired.

R² and R³ independently denote a straight-chain, branched-chain alicyclic or aromatic hydrocarbon group which has two bonding sites and in which a straight chain, a branched chain, an alicyclic unit and an aromatic unit may be selectively contained in any combined manner. An unsaturated bond may be contained, but a saturated hydrocarbon group is desirable. Among them, an alkylene group is particularly desirable.

R⁵ and R⁶ independently denote a straight-chain or branched-chain hydrocarbon group. The subscripts “x” and “y” denote independently an integer of two or more.

Specifically, for example, mention may be made of sulfurized sperm oil, sulfurized pinene oil, sulfurized soybean oil, sulfurized polyolefin, dialkyl disulfide, dialkyl polysulfide, dibenzyl disulfide, di-tertiary butyl disulfide, polyolefin polysulfide, thiadiazole type compound such as bis-alkyl polysulfanyl thiadiazole, and sulfurized phenol. Among these compounds, dialkyl polysulfide, dibenzyl disulfide, and thiadiazole type compound are desirable. Particularly desirable is bis-alkyl polysulfanyl thiadiazole.

The above ashless organic polysulfide compound (hereinafter referred to briefly as “polysulfide compound”) is added in an amount of 0.01 to 0.4 wt %, typically 0.1-0.3 wt %, and desirably 0.2-0.3 wt %, when calculated as sulfur (S), relative to the total amount of the lubricant composition. If the addition amount is less than 0.01 wt %, it is difficult to attain the intended effect, whereas if it is more than 0.4 wt %, there is a danger that corrosive wear increase.

Organic, ashless (metal-free), nitrogen-free friction modifiers which may be used in the lubricating oil compositions disclosed herein are known generally and include esters formed by reacting carboxylic acids and anhydrides with alkanols or glycols, with fatty acids being particularly suitable carboxylic acids. Other useful friction modifiers generally include a polar terminal group (e.g. carboxyl or hydroxyl) covalently bonded to an oleophilic hydrocarbon chain. Esters of carboxylic acids and anhydrides with alkanols are described in U.S. Pat. No. 4,702,850. A particularly desirable friction modifier to use in combination with the titanium compound is an ester such as glycerol monooleate (GMO).

### Metal-Containing Detergent

Metal-containing or ash-forming detergents function both as detergents to reduce or remove deposits and as acid neutralizers or rust inhibitors, thereby reducing wear and corrosion and extending engine life. Detergents generally comprise a polar head with a long hydrophobic tail, with the polar head comprising a metal salt of an acid organic compound. The salts may contain a substantially stoichiometric amount of the metal in which they are usually described as normal or neutral salts, and would typically have a total base number (TBN), as may be measured by ASTM D-2896 of from 0 to 80. It is possible to include large amounts of a metal base by reacting an excess of a metal compound such as an oxide or hydroxide with an acid gas such as carbon dioxide. The resulting overbased detergent comprises neutralized detergent as the outer layer of a metal base (e.g., carbonate) micelle. Such overbased detergents may have a TBN of 150 or greater, and typically from 250 to 450 or more.

Known detergents include oil-soluble neutral and overbased sulfonates, phenates, sulfurized phenates, thiophosphonates, salicylates, and naphthenates and other oil-soluble carboxylates of a metal, particularly the alkali or alkaline earth metals, e.g., sodium, potassium, lithium, calcium, and magnesium. The most commonly used metals are calcium and magnesium, which may both be present in detergents used in a lubricant, and mixtures of calcium and/or magnesium with sodium. Particularly convenient metal detergents are neutral and overbased calcium sulfonates having TBN of from about 20 to about 450 TBN, and neutral and overbased calcium phenates and sulfurized phenates having TBN of from about 50 to about 450.

In the disclosed embodiments, one or more calcium-based detergents may be used in an amount introducing from about 0.05 to about 0.6 wt. % calcium, sodium, or magnesium into the composition. The amount of calcium, sodium, or magnesium may be determined by Inductively Coupled Plasma (ICP) emission spectroscopy using the method described in ASTM D5185. Typically, the metal-based detergent is overbased and the total base number of the overbased detergent ranges from about 150 to about 450. More desirable, the metal-based detergent is an overbased calcium sulfonate detergent or an overbased magnesium sulfonates detergent.

### Antiwear Agents

Metal dihydrocarbyl dithiophosphate antiwear agents that may be added to the lubricating oil composition of the present invention comprise dihydrocarbyl dithiophosphate metal salts wherein the metal may be an alkali or alkaline earth metal, or aluminum, lead, tin, molybdenum, manganese, nickel, copper, titanium, or zinc. The zinc salts are most commonly used in lubricating oils.

Dihydrocarbyl dithiophosphate metal salts may be prepared in accordance with known techniques by first forming a dihydrocarbyl dithiophosphoric acid (DDPA), usually by reaction of one or more alcohol or a phenol with P₂S₅ and then neutralizing the formed DDPA with a metal compound. For example, a dithiophosphoric acid may be made by reacting mixtures of primary and secondary alcohols. Alternatively, multiple dithiophosphoric acids may be prepared where the hydrocarbyl groups on one are entirely secondary in character and the hydrocarbyl groups on the others are entirely primary in character. To make the metal salt, any basic or neutral metal compound may be used but the oxides, hydroxides and carbonates are most generally used. Commercial additives frequently contain an excess of metal due to the use of an excess of the basic metal compound in the neutralization reaction.

The zinc dihydrocarbyl dithiophosphates (ZDDP) that are typically used are oil soluble salts of dihydrocarbyl dithiophosphoric acids and may be represented by the following formula:

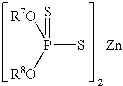

wherein R⁷ and R⁸ may be the same or different hydrocarbyl radicals containing from 1 to 18, typically 2 to 12, carbon atoms and including radicals such as alkyl, alkenyl, aryl, arylalkyl, alkaryl and cycloaliphatic radicals. Particularly desired as R⁷ and R⁸ groups are alkyl groups of 2 to 8 carbon atoms. Thus, the radicals may, for example, be ethyl, n-propyl, i-propyl, n-butyl, i-butyl, sec-butyl, amyl, n-hexyl, i-hexyl, n-octyl, decyl, dodecyl, octadecyl, 2-ethylhexyl, phenyl, butylphenyl, cyclohexyl, methylcyclopentyl, propenyl, butenyl. In order to obtain oil solubility, the total number of carbon atoms (i.e. R⁷ and R⁸) in the dithiophosphoric acid will generally be about 5 or greater. The zinc dihydrocarbyl dithiophosphate can therefore comprise zinc dialkyl dithiophosphates.

In order to limit the amount of phosphorus introduced into the lubricating oil composition by ZDDP to no more than 0.1 wt. % (1000 ppm), the ZDDP should desirably be added to the lubricating oil compositions in amounts no greater than from about 1.1 to 1.3 wt. %, based upon the total weight of the lubricating oil composition.

Other additives, such as the following, may also be present in lubricating oil compositions disclosed herein.

### Oxidation Inhibitors

Oxidation inhibitors or antioxidants reduce the tendency of base stocks to deteriorate in service which deterioration can be evidenced by the products of oxidation such as sludge and varnish-like deposits on the metal surfaces and by viscosity growth. Such oxidation inhibitors include hindered phenols, alkaline earth metal salts of alkylphenolthioesters having C₅ to C₁₂ alkyl side chains, calcium nonylphenol sulfide, ashless oil soluble phenates and sulfurized phenates, phosphosulfurized or sulfurized hydrocarbons, phosphorus esters, metal thiocarbamates and oil soluble copper compounds as described in U.S. Pat. No. 4,867,890.

### Antifoam Agents

Foam control can be provided by many compounds including an antifoamant of the polysiloxane type, for example, silicone oil or polydimethyl siloxane.

Other conventional additives may also be included in fully formulated lubricant compositions according to the disclosure. Some of the above-mentioned additives may provide a multiplicity of effects; thus for example, a single additive may act as a dispersant-oxidation inhibitor. This approach is well known and does not require further elaboration.

The individual additives may be incorporated into a base stock in any convenient way. Thus, each of the components can be added directly to the base stock or base oil blend by dispersing or dissolving it in the base stock or base oil blend at the desired level of concentration. Such blending may occur at ambient temperature or at an elevated temperature.

For example, all the additives may be blended into a concentrate as described herein as an additive package that is subsequently blended into base stock to make the finished lubricant. The concentrate will typically be formulated to contain the additive(s) in proper amounts to provide the desired concentration in the final formulation when the concentrate is combined with a predetermined amount of a base lubricant.

The final lubricating oil formulation may employ from about 2 to about 20 mass %, typically from about 4 to about 18 mass %, and desirably from about 5 to about 17 mass % of the concentrate or additive package with the remainder being base stock.

The additive components described above may be included in the lubricating oil compositions in an amount effective to allow the composition to reliably pass a Sequence VG test. For example, additives may be used in an amount sufficient to obtain a average engine sludge rating of greater than about 8.2 and an oil screen clogging rating of less than about 20%.

The dispersant system disclosed herein is used in combination with other additives. The additives are typically blended into the base oil in an amount that enables that additive to provide its desired function. Representative effective amounts of the additives used with the dispersant mixtures described herein for crankcase lubricants, are listed in Table 1 below. All the values listed are stated as weight percent active ingredient.

TABLE 1

| | Wt. % | Wt. % |
|---|---|---|
| Component | (Broad) | (Typical) |
| Antioxidant system | 0–5.0 | 0.01–3.0 |
| Metal Detergents | 0.1–15.0 | 0.2–8.0 |
| Corrosion Inhibitor | 0–5.0 | 0–2.0 |
| Metal dihydrocarbyl dithiophosphate | 0.1–6.0 | 0.1–4.0 |
| Antifoaming agent | 0–5.0 | 0.001–0.15 |
| Friction Modifier | 0–5.0 | 0–2.0 |
| Supplemental antiwear agents | 0–1.0 | 0–0.8 |
| Pour point depressant | 0.01–5.0 | 0.01–1.5 |
| Viscosity modifier | 0.01–10.00 | 0.25–7.0 |
| Base oil | balance | balance |
| Total | 100 | 100 |

TABLE 2

| Dispersant | | | |
|---|---|---|---|
| Number | SA/PIB Ratio | Wt. % N | Wt. % B |
| D1 | 1.8 | 1.55 | 0.00 |
| D2 | 1.8 | 1.21 | 0.86 |
| D3 | 1.6 | 1.03 | 0.00 |
| D4 | 1.1 | 1.57 | 0.80 |

TABLE 3

| | Dispersant(s) | | |
|---|---|---|---|
| Oil Number | (Table 2) | SA/PIB Ratio | B/N Ratio |
| 1 | D2 | 1.8 | 0.71 |
| 2 | D1/D2 | 1.8 | 0.62 |
| 3 | D1/D2 | 1.8 | 0.50 |
| 4 | D1/D2 | 1.8 | 0.30 |
| 5 | D2/D3 | 1.7 | 0.39 |
| 6 | D2/D3 | 1.7 | 0.56 |
| 7 | D1/D4 | 1.6 | 0.38 |
| 8 | D4 | 1.1 | 0.51 |
| Comparative | D3/D4 | 1.4 | 0.13 |
| Example 1 | | | |

### EXAMPLE 1

In order to evaluate the sludge reducing effect of a lubricant composition made according to the disclosed embodiments, a Sequence VG engine test was conducted. The Sequence VG test is a replacement test for Sequence VE, ASTM D 5302, sludge and varnish. The Sequence VG test measures a motor oil's ability to inhibit sludge and varnish formation. The engine was a fuel-injected gasoline engine, with roller followers, coolant-jacketed rocker covers, and camshaft baffles. The test was conducted on each oil for 216 hours and involved 54 cycles each with three different operating stages. At the end of each test, sludge deposits on rocker arm covers, cam baffles, timing chain cover, oil pan and oil pan baffle, valve decks was determined. Varnish deposits were determined for piston skirts and cam baffles. Sludge clogging was determine for the oil pump screen and the piston oil rings. Inspections were also conducted for “hot” and “cold” stuck piston compression rings.

The base oil was a base oil having a viscosity grade of 5W-30 formulated as a passenger car motor oil (PCMO). The total amount of additive in the base oil for each composition ranges from about 7.5 to about 11.5 weight percent.

A Sequence VG test was obtained on a PCMO 5W-30 oil formulated with a dispersant mixture and additive composition according to Oil 4, Table 3 above. The oil was compared to a PCMO 5W-30 oil containing a conventional additive package (Comparative Example 1, Table 3). The results are given in the following table.

TABLE 4

| | | | | Comparative |
|---|---|---|---|---|
| | | | | Example 1 |
| Test code | Criteria | | Oil 4 (Table 3) | (Table 3) |
| Average Engine Sludge | 7.75 | min | 8.98 | 8.19 |
| Rocker Cover Sludge | 7.95 | min | 9.73 | 9.45 |
| Average Engine Varnish | 8.86 | min | 9.11 | 9.14 |
| Piston Skirt Varnish | 7.46 | min | 7.86 | 8.14 |
| Oil Screen (Sludge) Clog | 20% | max | 9 | 40 |

| | | | |
|---|---|---|---|
| Hot Stuck Rings | None | 0 | 0 |

As shown by the foregoing results, dispersant mixtures according to this disclosure provided a significant reduction in oil screen sludge than the conventional additive package.

The applicability of lubricant compositions according to the disclosure for engine sludge reduction is not limited to the composition shown in this example. Accordingly, fully formulated lubricant composition containing the dispersant mixture in a Group I oil may include Group II, Group II+, Group III, and Group IV, base oils and mixtures thereof. It is believed that the disclosed embodiments may enable significant improvement in engine sludge reduction.

At numerous places throughout this specification, reference has been made to a number of U.S. Patents and publications. All such cited documents are expressly incorporated in full into this disclosure as if fully set forth herein.

The foregoing embodiments are susceptible to considerable variation in its practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

What is claimed is:

1. A lubricating oil composition comprising a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

2. The composition of claim 1, further comprising a metal containing detergent wherein the metal containing detergent is selected from the group consisting of calcium phenates, calcium salicylates, calcium sulfonates, magnesium phenates, magnesium salicylates, magnesium sulfonates, and mixtures thereof.

3. The composition of claim 1, wherein the detergent is an overbased calcium sulfonate.

4. The composition of claim 1, wherein at least one dispersant in the dispersant mixture is derived from a polyalkylene compound having a terminal vinylidene content of greater than about 65%.

5. The composition of claim 1, wherein the dispersant has a number average molecular weight of ranging from about 1000 to about 3000 as determined by Gel Permeation Chromatography (GPC).

6. The composition of claim 1, further comprising at least one additive selected from the group consisting of friction modifiers, antioxidants, detergents, and anti-wear agents.

7. The composition of claim 1, wherein the composition is substantially free of molybdenum compounds.

8. The composition of claim 1, wherein the dispersant has an average weight ratio of carboxylic acylating agent to polyalkylene compound of greater than about 1.7.

9. The composition of claim 1, wherein the dispersant comprising a first dispersant derived from the polyalkylene compound having a number average molecular weight ranging from above about 1300 to about 3000 as determined by GPC and a vinylidene content of greater than about 65 wt. %.

10. The composition of claim 1, further comprising a hydrocarbon soluble titanium compound wherein the titanium compound is substantially devoid of sulfur and phosphorus atoms.

11. The composition of claim 1, further comprising a at least one metal dihydrocarbyl dithiophosphate compound wherein the metal of the at least one metal dihydrocarbyl dithiophosphate metal compound is selected from the group consisting of an alkali metal, an alkaline earth metal, aluminum, lead, tin, molybdenum, manganese, nickel, copper, titanium, and zinc.

12. The composition of claim 11, wherein the at least one metal dihydrocarbyl dithiophosphate compound comprises an aryl zinc dihydrocarbyl dithiophosphate compound.

13. The composition of claim 1, further comprising a hydrocarbon soluble titanium compound devoid of sulfur and phosphorus atoms and a friction modifier selected from the group consisting of metal-free ester compounds and nitrogen containing compounds.

14. The composition of claim 13, wherein the friction modifier comprises a compound selected from the group consisting of alkoxylated amines, alkoxylated ether amines, and thiadiazoles.

15. The composition of claim 13, wherein the friction modifier comprises glycerol monooleate.

16. The composition of claim 1, wherein said composition contains from about 0.025 wt. % to less than about 0.1 wt. % phosphorus.

17. The composition of claim 16, wherein said composition contains from about 0.025 wt. % to about 0.075 wt. % phosphorus.

18. A method for reducing engine sludge of an internal combustion engine, which comprises: (1) adding to the engine the lubricating oil composition of claim 1; and (2) operating said engine.

19. A lubricated surface comprising a lubricant composition containing a base oil of lubricating viscosity and an additive package comprising a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

20. The lubricated surface of claim 19, wherein the lubricated surface comprises an engine drive train.

21. The lubricated surface of claim 19, wherein the lubricated surface comprises an internal surface or component of an internal combustion engine.

22. The lubricated surface of claim 19, wherein the lubricated surface comprises an internal surface or component of a compression ignition engine.

23. The lubricated surface of claim 19, wherein the additive package further comprises a detergent selected from the group consisting of calcium phenates, calcium salicylates, calcium sulfonates, magnesium phenates, magnesium salicylates, magnesium sulfonates, and mixtures thereof.

24. The lubricated surface of claim 19, wherein the additive package further comprises a friction modifier selected from the group consisting of hydrocarbon soluble titanium compounds, glycerol esters, and amine compounds.

25. A motor vehicle comprising the lubricated surface of claim 19.

26. A vehicle having moving parts and containing a lubricant for lubricating the moving parts, the lubricant comprising an oil of lubricating viscosity and an additive package comprising a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

27. The vehicle of claim 26, wherein the additive package further comprises a friction modifier selected from the group consisting of hydrocarbon soluble titanium compounds, glycerol esters, and amine compounds.

28. The vehicle of claim 26, wherein the moving parts comprise a heavy duty diesel engine.

29. A fully formulated lubricant composition comprising a base oil component of lubricating viscosity and an amount of sludge reducing lubricant additive wherein the lubricant additive comprises a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

30. The lubricant composition of claim 29, wherein the lubricant composition comprises a low ash, low sulfur, and low phosphorus lubricant composition suitable for compression ignition engines.

31. The lubricant composition of claim 29, wherein the phosphorus content ranges from about 250 to about 500 ppm in the lubricant composition.

32. The lubricant composition of claim 30, wherein the additive further comprises a friction modifier selected from the group consisting of hydrocarbon soluble titanium compounds, glycerol esters, and amine compounds.

33. A lubricant additive concentrate for providing reduced sludge in a lubricant composition, comprising a hydrocarbyl carrier fluid and a dispersant mixture derived from a reaction product of polyalkylene compound, a carboxylic acylating agent, and a polyamine, wherein the polyalkylene compound of at least one dispersant in the dispersant mixture has a number average molecular weight of at least about 1200 and at least one dispersant in the dispersant mixture contains boron such that a weight ratio of boron to nitrogen (B/N) in the dispersant mixture ranges from above about 0.25 to about 1.0.

34. The additive concentrate of claim 33, further comprising a hydrocarbon soluble titanium compound as a friction modifier providing from about 10 to about 500 ppm titanium to the lubricant composition.

35. A lubricant composition comprising a base oil and the additive concentrate of claim 33.
